(19) United States
(12) Patent Application Publication
(10) Pub. No.: US 2013/0065125 A1
(43) Pub. Date: Mar. 14, 2013

(54) ELECTRODE FOR LITHIUM ION SECONDARY BATTERY, METHOD FOR PRODUCING THE SAME, AND LITHIUM ION SECONDARY BATTERY

(71) Applicants: Yuko Sawaki, Kyoto (JP); Mitsuhiro Kishimi, Kyoto (JP)

(72) Inventors: Yuko Sawaki, Kyoto (JP); Mitsuhiro Kishimi, Kyoto (JP)

(21) Appl. No.: 13/395,067

(22) PCT Filed: Sep. 13, 2011
(86) PCT No.: PCT/JP2011/070817

§ 371 Date: Mar. 8, 2012

(51) Int. Cl. H01M 4/62; B05D 5/12; B82Y 99/00; B82Y 30/00

(52) U.S. Cl. 429/212; 427/122; 977/948; 977/742

(57) ABSTRACT

The electrode for a lithium ion secondary battery of the present invention has an electrode mixture layer containing carbon nanotubes as a conductive auxiliary agent and deoxyribonucleic acid as a dispersant for the carbon nanotubes, and the content of the carbon nanotubes in the electrode mixture layer is 0.001 to 5 parts by mass with respect to 100 parts by mass of active material particles. The lithium ion secondary battery of the present invention has the electrode of the invention as its positive electrode and/or negative electrode. The electrode of the invention can be produced by a producing method of the invention of forming the electrode mixture layer from an electrode mixture-containing composition prepared using a dispersion including carbon nanotubes and deoxyribonucleic acid.

### TECHNICAL FIELD

The present invention relates to electrodes for lithium ion secondary batteries containing carbon nanotubes as a conductive auxiliary agent, a producing method thereof, and lithium ion secondary batteries having such electrodes.

### BACKGROUND ART

Lithium ion secondary batteries are being developed rapidly as batteries for use in mobile electronic devices, hybrid cars, etc. In such lithium ion secondary batteries, carbon materials are mainly used as negative-electrode active materials, and metal oxides, metal sulfides, various types of polymers, etc. are used as positive-electrode active materials. In particular, lithium composite oxides such as lithium cobaltate, lithium nickelate, and lithium manganate are currently in common use as the positive-electrode active materials of the lithium ion secondary batteries because, using such oxides, batteries with high energy density and high voltage can be fabricated.

As electrodes (positive electrodes or negative electrodes) for the lithium ion secondary batteries, used are ones having an electrode mixture layer (positive-electrode mixture layer or negative-electrode mixture layer) containing an active material, a binder, a conductive auxiliary agent, etc., for example, formed on a current collector. As the conductive auxiliary agent of such electrodes, particulate matters such as carbon black are generally used.

With the recent enhancement in the performance of applied devices, there have been demands for further increase in the capacity of the lithium ion secondary batteries. To increase the capacity of the lithium ion secondary batteries, methods have been examined including, for example, a method in which the electrode mixture layer of an electrode is thickened and the current collector portion put in the battery is reduced, to increase the amount of the active material in the battery and a method in which a high-capacity active material is under consideration.

However, if the electrode mixture layer of the electrode is thickened, for example, the distance from the surface of the electrode mixture layer away from the current collector to the current collector will become long, making it difficult for a nonaqueous electrolytic solution to permeate to a portion of the electrode mixture layer near the current collector. Therefore, when the electrode mixture layer is thickened, it is requested to reduce the density of the electrode mixture layer, for example, to enhance the permeability of the nonaqueous electrolytic solution. In this case, however, the distance between the active material particles, and the distance between the active material particles and the conductive auxiliary agent particles, in the electrode mixture layer become long, causing insufficient electron conductivity in the electrode mixture layer, and thus decrease in the use efficiency of the active material. A battery having such an electrode will fail to secure the estimated capacity and deteriorate in its load characteristics.

Also, it is known that the materials usable as the negative-electrode active material are generally large in the change of the volume with the charge/discharge of the battery, compared with the materials used as the positive-electrode active material. In general, this volume change is larger as the capacity of the negative-electrode active material is larger. Therefore, it is preferable to reduce the density of the electrode mixture layer to allow for an expansion of the negative-electrode active material. This will however increase the distance between the active material particles, and the distance between the active material particles and the conductive auxiliary agent particles, in the electrode mixture layer, causing problems similar to those occurring when the electrode mixture layer is thickened.

To solve the above problems, it is considered to use a conductive auxiliary agent with which the electron conductivity between the active material particles apart from each other by a long distance can be retained satisfactorily.

Patent Document 1, for example, proposes a technique using carbon nanotubes as a conductive auxiliary agent of the positive electrode of a secondary battery. Carbon nanotubes are in the form of hollow fibers, and it is considered that, with use of carbon nanotubes, the electron conductivity between active material particles can be secured even when the distance between the active material particles is comparatively long. There is therefore the possibility that the above problems may be solved by use of carbon nanotubes.

### PRIOR ART DOCUMENT

### Patent Document

Patent Document 1 JP 2003-77476A

### DISCLOSURE OF INVENTION

### Problem to be Solved by the Invention

Carbon nanotubes have the property of occluding lithium (Li) ions by themselves, but also have the nature of not easily releasing once-occluded Li. Therefore, in use of carbon nanotubes as a conductive auxiliary agent of an electrode for a lithium ion secondary battery, when the use amount is increased, the electron conductivity in an electrode mixture layer may improve, but the irreversible capacity may possibly increase.

Carbon nanotubes are normally in the state of bundles of several nanotubes put together. The effect of improving the electron conductivity does not change between one bundle and one separated carbon nanotube. Therefore, it is more desirable to loosen the bundle into individual carbon nanotubes and use them separately to reduce the amount of carbon nanotubes used, than to use the bundle as it is, because, with the reduced use amount, it is possible to reduce the increase of the irreversible capacity as much as possible while enhancing the electron conductivity in the electrode mixture layer.

As the method of loosening the bundle of carbon nanotubes, a method using a dispersant containing an organic high polymer such as a surfactant is taken for instance. In this method, however, carbon nanotubes are covered with the dispersant, reducing the contact probability between the carbon nanotubes and the contact probability between the carbon nanotubes and active material particles. Moreover, since a larger amount of dispersant is required to loosen the bundles more satisfactorily, the amount of the dispersant, which is an insulating material put in the battery, increases. As a result, the effect of improving the electron conductivity will be rather impaired.

The above being the case, the present status is that the effectiveness of carbon nanotubes as a conductive auxiliary agent of an electrode for a lithium ion secondary battery has not yet been derived sufficiently.

In view of the above, it is an objective of the present invention to provide an electrode that uses carbon nanotubes as a conductive auxiliary agent and yet can constitute a lithium ion secondary battery having good battery characteristics, a producing method thereof, and a lithium ion secondary battery having such an electrode.

### Means for Solving the Problem

The electrode for a lithium ion secondary battery that can achieve the above objective is an electrode having an electrode mixture layer containing active material particles capable of occluding/releasing Li, a conductive auxiliary agent, and a resin binder, wherein the electrode mixture layer contains carbon nanotubes as the conductive auxiliary agent and deoxyribonucleic acid as a dispersant for the carbon nanotubes, and the content of the carbon nanotubes in the electrode mixture layer is 0.001 to 5 parts by mass with respect to 100 parts by mass of the active material particles.

The electrode for a lithium ion secondary battery of the present invention can be produced by the producing method of the present invention including the steps of preparing a carbon nanotube dispersion containing deoxyribonucleic acid, carbon nanotubes, and a solvent; preparing an electrode mixture-containing composition by mixing active material particles and a resin binder in the carbon nanotube dispersion; and forming an electrode mixture layer by applying the electrode mixture-containing composition to a current collector and drying the composition.

The lithium ion secondary battery of the present invention has a positive electrode, a negative electrode, a nonaqueous electrolytic solution, and a separator, wherein the positive electrode and/or the negative electrode is the electrode for a lithium ion secondary battery of the present invention.

### Effects of the Invention

According to the present invention, an electrode that uses carbon nanotubes as a conductive auxiliary agent and yet can constitute a lithium ion secondary battery having good battery characteristics, a producing method thereof, and a lithium ion secondary battery having such an electrode can be provided. In other words, the lithium ion secondary battery of the present invention has a positive electrode and/or a negative electrode containing carbon nanotubes as a conductive auxiliary agent and yet has good battery characteristics.

### DESCRIPTION OF THE INVENTION

The electrode for a lithium ion secondary battery (hereinafter simply referred to as the “electrode” in some cases) of the present invention has an electrode mixture layer containing active material particles capable of occluding/releasing Li, a conductive auxiliary agent, and a resin binder. Such an electrode mixture layer is formed on one side or both sides of a current collector; for example. The electrode of the present invention is used for the positive electrode or the negative electrode of a lithium ion secondary battery.

The electrode mixture layer of the electrode of the present invention contains carbon nanotubes as the conductive auxiliary agent and also contains deoxyribonucleic acid (DNA) as the dispersant for the carbon nanotubes. In other words, the electrode of the present invention contains carbon nanotubes released from bundles by the action of DNA in the electrode mixture layer.

For example, when bundles of carbon nanotubes are dispersed in a solution prepared by dissolving DNA in a solvent, the DNA, having a double-helical structure, winds around the carbon nanotubes, allowing the bundles to be loosened easily. As a result, a dispersion where individual carbon nanotubes are dispersed separately in the solvent can be obtained. By using such a carbon nanotube dispersion, it is possible to obtain the electrode of the present invention having the electrode mixture layer containing DNA as the dispersant for carbon nanotubes and the carbon nanotubes released from bundles.

More specifically, three or more carbon nanotubes are normally put together to form a bundle. However, in the electrode of the present invention, the average value of the numbers of carbon nanotubes included in nanotube-present regions of the electrode mixture layer where carbon nanotubes dispersed in the electrode mixture layer are present can be reduced to less than two. It is preferable that all carbon nanotubes dispersed in the electrode mixture layer have been released from bundles. Therefore, it is more preferable that the average value of the numbers of carbon nanotubes included in the nanotube-present regions of the electrode mixture layer where carbon nanotubes dispersed in the electrode mixture layer are present is closer to one, and it is especially preferable that it is one.

The average value of the numbers of carbon nanotubes included in nanotube-present regions of the electrode mixture layer where carbon nanotubes dispersed in the electrode mixture layer are present as used herein refers to the average value obtained in the following manner: the cross section of the electrode mixture layer is observed with a transmission electron microscope (TEM), to count the number of carbon nanotubes present in each of 100 carbon nanotube-present regions, and the sum of these numbers is divided by the total number of carbon nanotube-present regions (100) to obtain the average value.

The DNA does not easily decompose with the battery voltage of a normal lithium ion secondary battery. In the electrode of the present invention, therefore, it is possible to prevent or reduce deterioration in battery characteristics that may occur by the presence of a component (the dispersant for carbon nanotubes) that is not involved in the battery reaction in the electrode mixture layer.

As the carbon nanotubes for the electrode of the present invention, any of single-wall ones and multi-wall ones can be used.

From the standpoint of securing the electron conductivity between active material particles apart from each other by a comparatively long distance more satisfactorily, the average length of the carbon nanotubes used in the electrode of the present invention is preferably 50 nm or more, more preferably 1 μm or more. It is considered that, the longer the carbon nanotubes, the higher the effect will be as for their property of coupling the active material particles to each other. However, excessively long carbon nanotubes are hard to produce and require high cost, causing the possibility of impairing the productivity of the electrode. Therefore, the average length of the carbon nanotubes used in the electrode of the present invention is preferably 5 μm or less, more preferably 3 μm or less.

The average length of the carbon nanotubes as used herein refers to the average length obtained by measuring the length of each of 100 TEM-observed carbon nanotubes and dividing the sum of the lengths by the number of carbon nanotubes (100).

In the electrode of the present invention, the content of the carbon nanotubes in the electrode mixture layer is 5 parts by mass or less, preferably 1 part by mass or less, more preferably 0.5 parts by mass or less, with respect to 100 parts by mass of active material particles. In the electrode of the present invention, in which the carbon nanotubes released from bundles by the action of DNA are contained in the electrode mixture layer, good electron conductivity can be secured even with a reduced amount of carbon nanotubes as described above. Therefore, it is possible to reduce the increase of the irreversible capacity due to the use of carbon nanotubes and the resultant deterioration in load characteristics as much as possible.

Also, in the electrode of the present invention, from the standpoint of securing the effect of improving the electron conductivity with use of carbon nanotubes satisfactorily, the content of the carbon nanotubes in the electrode mixture layer is 0.001 parts by mass or more, preferably 0.1 parts by mass or more, with respect to 100 parts by mass of active material particles.

In the electrode of the present invention, the content of the DNA in the electrode mixture layer is preferably 30 parts by mass or more, more preferably 70 parts by mass or more, with respect to 100 parts by mass of carbon nanotubes. Using the DNA as the dispersant, the bundles of carbon nanotubes can be loosened satisfactorily even with such an amount of DNA. Therefore, the occurrence of the carbon nanotubes being covered with the DNA can be reduced, securing the contacts with the active material particles satisfactorily.

If the amount of the DNA in the electrode mixture layer is excessively large, the effect will be saturated and also the amount of components unnecessary for the battery reaction in the battery will increase. Hence, in the electrode of the present invention, the content of the DNA in the electrode mixture layer is preferably 120 parts by mass or less, more preferably 110 parts by mass or less, with respect to 100 parts by mass of carbon nanotubes.

In the electrode of the present invention, when graphite is used as the negative-electrode active material, for example, the thickness of the electrode mixture layer (thickness of the portion of the electrode mixture layer on one side of the current collector when the electrode mixture layer is formed on both sides of the current collector; this also applies to the thickness of the electrode mixture layer to follow) is preferably 80 μm or more, more preferably 100 μm or more, from the standpoint of increasing the capacity of the lithium ion secondary battery having this electrode, although this depends on the kind of the negative-electrode active material used.

As described earlier, when the electrode mixture layer is thickened to increase the capacity of the battery, the nonaqueous electrolytic solution may not penetrate to the entire of the electrode mixture layer sufficiently. For example, the nonaqueous electrolytic solution may be insufficient in a portion near the current collector, causing failure in taking out the estimated battery capacity sufficiently and deterioration in the load characteristics and charge/discharge cycle characteristics of the battery. Therefore, along with thickening the electrode mixture layer, it is preferable to reduce the density of the electrode mixture layer. In this case, however, since the distance between the active material particles in the electrode mixture layer becomes long, the electron conductivity decreases, possibly causing decrease in the capacity of the battery, deterioration in load characteristics, and deterioration in charge/discharge cycle characteristics.

According to the electrode of the present invention, however, a good conductive path can be formed, by the action of the carbon nanotubes, even between the active material particles the distance between which has become long with the reduced density of the electrode mixture layer. It is therefore possible to retain the load characteristics and charge/discharge cycle characteristics of the battery at high level while thickening the electrode mixture layer to increase the capacity of the battery as described above.

If the electrode mixture layer is excessively thick, the electron conductivity may decrease in a portion near the surface of the current collector on the opposite side, possibly reducing the effect of improving the electron conductivity in the electron mixture layer by the use of the carbon nanotubes. Therefore, in the electrode of the present invention, the thickness of the electrode mixture layer is preferably 200 μm or less, more preferably 150 μm or less.

It is preferable for the electrode mixture layer of the electrode of the present invention to contain a particulate conductive auxiliary agent together with the carbon nanotubes. With such a particulate conductive auxiliary agent contained in the electrode mixture layer together with the carbon nanotubes, the electron conductivity between active material particles apart from each other by a comparatively short distance can be secured with the particulate conductive auxiliary agent. This permits better formation of a conductive network in the electrode mixture layer.

Examples of the particulate conductive auxiliary agent include: graphite such as natural graphite (scaly graphite, etc.) and artificial graphite; and carbon black such as acetylene black, Ketjen black, channel black, furnace black, lamp black, and thermal black. Only one type of the above, or a combination of two or more types thereof, may be used. Among these particulate conductive auxiliary agents, acetylene black or furnace black is preferably used because they are highest in general versatility and can be produced stably at low cost.

In the electrode of the present invention, from the standpoint of securing the effect obtained by the use of the particulate conductive auxiliary agent described above satisfactorily, the content of the particulate conductive auxiliary agent in the electrode mixture layer is preferably 0.5 parts by mass or more, preferably 1 part by mass or more, with respect to 100 parts by mass of active material particles. However, if the amount of the particulate conductive auxiliary agent in the electrode mixture layer is excessively large, the amount of active material particles in the electrode mixture layer may decrease, possible causing decrease in capacity. Therefore, in the electrode of the present invention, the content of the particulate conductive auxiliary agent in the electrode mixture layer is preferably 10 parts by mass or less, preferably 5 parts by mass or less, with respect to 100 parts by mass of active material particles.

When the electrode of the present invention is used as the negative electrode for a lithium ion secondary battery, active material particles used for negative electrodes for conventionally known lithium ion secondary batteries, i.e., particles of an active material capable of occluding/releasing Li, can be used as the active material particles. Specific examples of such active material particles include particles of carbon materials such as graphite (natural graphite, artificial graphite obtained by graphitizing easily-graphitizable carbon such as pyrolytic carbon, mesophase carbon microbeads (MCMB), and carbon fibers at 2800° C. or more, etc.), pyrolytic carbon, coke, glassy carbon, burned substances of organic polymeric compounds, MCMB, carbon fibers, activated carbon, etc.; and metals (Si, Sn, etc.) that can be alloyed with lithium and materials (alloys, oxides, etc.) including such metals. In using the electrode of the present invention as the negative electrode for a lithium ion secondary battery, only one type, or a combination of two or more types, of the above active material particles may be used.

When increasing the capacity of the battery is especially intended, it is preferable to use a material including Si and O as constituent elements (the atom ratio p of O to Si is 0.5≦p≦1.5; hereinafter this material is referred to as “SiOₚ”) among the negative-electrode active materials described above.

SiOₚ may include microcrystalline or amorphous Si, and in this case, the atom ratio of 0 to Si will be the ratio including such microcrystalline or amorphous Si. That is, SiOₚ may include a structure where Si (e.g., microcrystalline Si) is dispersed in an amorphous SiO₂ matrix, and the atom ratio p of this amorphous SiO₂ and the Si dispersed therein in total should satisfy 0.5≦p≦1.5. For example, when a material having a structure of Si dispersed in an amorphous SiO₂ matrix has a mole ratio of SiO₂ to Si of 1:1, this material is expressed by SiO because p=1. In analysis of such a material, peaks caused by the presence of Si (microcrystalline Si) may not be observed by X-ray diffraction analysis, for example, in some cases, but the presence of fine Si can be recognized when observed with a transmission electron microscope.

Since SiOₚ has low conductivity, the surface of SiOₚ may be coated with carbon, for example. This permits better formation of the conductive network in the negative electrode.

As the carbon for coating of the surface of SiOₚ, low-crystalline carbon, carbon nanotubes, vapor-grown carbon fibers, etc. may be used.

When the surface of SiOₚ is coated by a method in which a carbon hydride gas is heated in the vapor phase and the carbon produced by thermal decomposition of the carbon hydride gas is deposited on the surfaces of SiOₚ particles (chemical vapor deposition (CVD)), the carbon hydride gas reaches every portion of the surfaces of the SiOₚ particles, permitting formation of a thin, uniform membrane including conductive carbon (carbon coat layer) on the surfaces of the particles and in holes on the surfaces. Thus, conductivity can be imparted to SiOₚ particles with good uniformity using a small amount of carbon.

As a liquid source for the carbon hydride gas used in the CVD method, toluene, benzene, xylene, mesitylene, etc. may be used. Toluene, which is easy to handle, is especially preferred. By vaporizing (e.g., bubbling with nitrogen gas) such a material, the carbon hydride gas can be obtained. Otherwise, methane gas, ethylene gas, acetylene gas, etc. may be used.

The processing temperature in the CVD method is preferably 600 to 1200° C., for example. The SiOₚ to be subjected to the CVD method is preferably a granulated material (composite particles) granulated by a known technique.

When the surface of SiOₚ is coated with carbon, the amount of carbon is preferably 5 parts by mass or more, more preferably 10 parts by mass or more, and preferably 95 parts by mass or less, more preferably 90 parts by mass or less, with respect to 100 parts by mass of SiOₚ.

Since SiOₚ largely changes in its volume with the charge/discharge of the battery, as do the other high-capacity negative-electrode materials, it is preferable to use a combination of SiOₚ and graphite as the negative-electrode active material. With this combined use, it is possible to increase the capacity by the use of SiOₚ while retaining the charge/discharge cycle characteristics at high level by reducing the expansion/contraction of the negative electrode occurring with the charge/discharge of the battery

When SiOₚ and graphite are used in combination as the negative-electrode active material, the percentage of SiOₚ in the total amount of the negative-electrode active material is preferably 0.5 mass % or more from the standpoint of securing the effect of increasing the capacity by the use of SiOₚ satisfactorily, and preferably 10 mass % or less from the standpoint of reducing the expansion/contraction of the negative electrode due to SiOₚ.

When the electrode of the present invention is used as the positive electrode for a lithium ion secondary battery, active material particles used for positive electrodes for conventionally known lithium ion secondary batteries, i.e., particles capable of occluding/releasing Li, can be used as the active material particles. Specific examples of such active material particles include particles of layered-structure lithium-containing transition metal oxides expressed by Li_{1+c}M¹O₂ (0.1<c<0.1, M¹: Co, Ni, Mn, Al, Mg. etc.); spinel-structure lithium manganese oxides such as LiMn₂O₄ and ones an element of which has been partly replaced with another element; and olivine-type compounds expressed by LiM²PO₄ (M²; Co, Ni, Mn, Fe, etc.). Specific examples of the layered-structure lithium-containing transition metal oxides include LiCoO₂, LiNi_{1-d}Co_{d-e}AlₑO₂ (0.1≦d≦0.3, 0.01≦e≦0.2), and oxides including at least Co, Ni, and Mn (LiMn_{1/3}Ni_{1/3}Co_{1/3}O₂, LiMn_{5/12}Ni_{5/12}Co_{1/6}O₂, LiMn_{3/5}Ni_{1/5}Co_{1/5}O₂, etc.). In using the electrode of the present invention as the positive electrode for a lithium ion secondary battery, only one type, or a combination of two or more types, of the above active material particles may be used.

An allowance for the expansion of the negative-electrode active material particles is provided for the negative-electrode mixture layer because the negative-electrode active material particles are large in the amount of volume change with the charge/discharge of the battery, compared with the positive-electrode active material particles. It is therefore preferable to make the density of the negative-electrode mixture layer lower than that of the positive-electrode mixture layer. Thus, the effect of the electrode of the present invention can be exerted more satisfactorily when the electrode is used as the negative electrode for a lithium ion secondary battery.

Also, large-capacity negative-electrode active material particles (e.g., SiOₚ described above) are larger in the amount of volume change with the charge/discharge of the battery than small-capacity ones, thereby requiring a larger expansion allowance, and thus it is preferable to reduce the density of the negative-electrode mixture layer. Therefore, the effect of the electrode of the present invention can be exerted more significantly when the electrode is used as the negative electrode for a lithium ion secondary battery containing larger-capacity negative-electrode active material particles.

The average particle size of primary particles, as measured by the same method as that for the oxide particles described above, of the active material particles used when the electrode of the present invention is used as the negative electrode for a lithium ion secondary battery and the active material particles used when the electrode of the present invention is used as the positive electrode for a lithium ion secondary battery is preferably 50 nm or more and 500 μm or less, more preferably 10 μm or less.

As the resin binder contained in the electrode mixture layer of the electrode of the present invention, the same resin binders as those used in positive-electrode mixture layers of positive electrodes, and negative-electrode mixture layers of negative electrodes, for conventionally known lithium ion secondary batteries can be used. Specifically, polyvinylidene fluoride (PVDF), polytetrafluoroethylene (PTFE), styrene-butadiene rubber (SBR), carboxymethyl cellulose (CMC), etc. are taken as preferred examples.

When the electrode of the present invention is used as the negative electrode for a lithium ion secondary battery, the amount of the active material particles in the electrode mixture layer (negative-electrode mixture layer) is preferably 85 to 99 mass %, and the amount of the resin binder therein is preferably 1.0 to 10 mass %. Also, the density of the electrode mixture layer (negative-electrode mixture layer) for use of the electrode of the present invention as the negative electrode for a lithium ion secondary battery is preferably 1.3 to 1.65 g/cm³.

The density of the electrode mixture layer (the density of the negative-electrode mixture layer described above, and the density of the positive-electrode mixture layer to be described later) as used herein refers to the value measured in the following manner. The electrode is cut into a portion having a predetermined area, the mass of the portion is measured with an electron balance having a minimum scale value of 0.1 mg, and the mass of the current collector is subtracted from the measured value, to obtain the mass of the electrode mixture layer. Meanwhile, the total thickness of the electrode is measured at ten points with a micrometer having a minimum scale value of 1 μm, the thickness of the current collector is subtracted from the measured values, and the resultant values are averaged. From this average value and the area, the volume of the electrode mixture layer is calculated. The density of the electrode mixture layer is then calculated by dividing the mass of the electrode mixture layer by the volume.

When the electrode of the present invention is used as the negative electrode for a lithium ion secondary battery having a current collector, foil, punched metal, a mesh, expanded metal, etc. made of copper or nickel may be used as the current collector. Copper foil is generally used. The thickness of the current collector is preferably 5 to 30 μm.

When the electrode of the present invention is used as the positive electrode for a lithium ion secondary battery, the amount of the active material particles in the electrode mixture layer (positive-electrode mixture layer) is preferably 75 to 95 mass %, and the amount of the resin binder therein is preferably 2 to 15 mass %. Also, the density of the electrode mixture layer (positive-electrode mixture layer) for use of the electrode of the present invention as the positive electrode for a lithium ion secondary battery is preferably 2.4 to 2.6 g/cm³ when spinel manganese is used as the active material, for example, although this depends on the true density of the material used as the active material. As another feature, it is preferable to have a porosity of about 30 to 40 vol. %, which also applies when the type of the active material is changed.

When the electrode of the present invention is used as the positive electrode for a lithium ion secondary battery having a current collector, foil, punched metal, a mesh, expanded metal, etc. made of aluminum may be used as the current collector. Aluminum foil is generally used. The thickness of the current collector is preferably 10 to 30 μm.

The electrode of the present invention can be produced by a producing method of the present invention having the steps of (1) preparing a carbon nanotube dispersion containing DNA, carbon nanotubes, and a solvent; (2) preparing an electrode mixture-containing composition by mixing the carbon nanotube dispersion with active material particles, a resin binder, etc.; and (3) forming an electrode mixture layer by applying the electrode mixture-containing composition to the current collector and drying the composition.

In the step (1) of the producing method of the present invention, the carbon nanotube dispersion containing DNA, carbon nanotubes, and a solvent is prepared. A solution with DNA dissolved in the solvent is first prepared, and bundles of carbon nanotubes are added to and dissolved in the solution. By this step, a dispersion including the carbon nanotubes released from the bundles by the action of the DNA in the solution can be obtained.

As the solvent used for the preparation of the carbon nanotube dispersion, any solvent can be used if only the DNA can be dissolved therein, and water and polar organic solvents can be used. However, since this solvent also serves as the solvent of the electrode mixture-containing composition for formation of the electrode mixture layer, it is preferable to use water and N-methyl-2-pyrrolidone (NMP) that are used widely as the solvent of the electrode mixture-containing composition.

To allow dispersion of the carbon nanotubes into the DNA solution, a medialess dispersion method weak in shear force, such as ultrasonic dispersion and stirring using a magnetic stirrer and a three-one motor, for example, can be used. If the dispersion process is performed for a long time by a method strong in shear force, the carbon nanotubes and the DNA may be cut in some cases.

In the step (2) of the producing method of the present invention, the active material particles and a resin binder, and additionally a particulate conductive auxiliary agent, etc., as required, are mixed in the carbon nanotube dispersion prepared in the step (1), to prepare the electrode mixture-containing composition.

In the mixing of the active material particles, the resin binder, the particulate conductive auxiliary agent, etc. with the oxide particle dispersion, it is possible to use a disperser using dispersion media such as zirconia beads. However, with the possibility that such dispersion media may damage the active material particles, it is more preferable to use a medialess disperser. Examples of the medialess disperser include general-purpose dispersers such as a hybrid mixer, Nanomizer, and a jet mill.

In the step (3) of the producing method of the present invention, the electrode mixture-containing composition prepared in the step (2) is applied to the current collector and dried, to form the electrode mixture layer. No limitation is specifically imposed on the method of applying the electrode mixture-containing composition to the current collector, but any of a variety of known application methods can be employed.

The electrode after the formation of the electrode mixture layer may be subjected to pressing as required, and leads for connection to terminals in the battery may be formed according to a common procedure.

The lithium ion secondary battery (hereinafter simply referred to as the “battery” in some cases) of the present invention includes the positive electrode, the negative electrode, the nonaqueous electrolytic solution, and a separator. It is only essential that at least one of the positive electrode and the negative electrode is the electrode for a lithium ion secondary battery of the present invention. No limitation is specifically imposed on the other configuration and structure, but any of a variety of configurations and structures employed for conventionally known lithium ion secondary batteries can be used.

In the battery of the present invention, only one of the positive electrode and the negative electrode, or both of them, may be the electrode of the present invention. When only the negative electrode of the battery of the present invention is the electrode of the present invention, the positive electrode can be a positive electrode having the same configuration as the electrode (positive electrode) of the present invention except that it contains neither carbon nanotubes nor DNA. Likewise, when only the positive electrode of the battery of the present invention is the electrode of the present invention, the negative electrode can be a negative electrode having the same configuration as the electrode (negative electrode) of the present invention except that it contains neither carbon nanotubes nor DNA. Note however that, in the positive electrode of the battery where only the negative electrode is the electrode of the present invention, the particulate conductive auxiliary agent is contained in the positive-electrode mixture layer for securing the electron conductivity.

The separator of the battery of the present invention preferably has the nature of closing its pores (i.e., the shutdown function) at 80° C. or more (more preferably 100° C. or more) and 170° C. or less (more preferably 150° C. or less). Separators used for normal lithium ion secondary batteries, etc., e.g., microporous membranes made of polyolefin such as polyethylene (PE) and polypropylene (PP), can be used. The microporous membrane constituting the separator may be made of only PE or PP, or otherwise may be a laminate of a PE microporous membrane and a PP microporous membrane. The thickness of the separator is preferably 10 to 30 μm, for example.

The positive electrode, the negative electrode, and the separator described above can be used for the battery of the present invention in the form of a laminated electrode body where the positive electrode and the negative electrode are placed one upon the other with the separator interposed therebetween, or further in the form of a wound electrode body where the laminated electrode body is wound helically.

As the nonaqueous electrolytic solution of the battery of the present invention, used is one prepared by dissolving at least one type selected from lithium salts such as LiClO₄, LiPF₈, LiBF₄, LiAsF₆, LiSbF₆, LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃≧2), and LiN(R_{f}OSO₂)₂ (where R_{f} is a fluoroalkyl group), for example, in an organic solvent such as dimethyl carbonate, diethyl carbonate, methylethyl carbonate, methyl propionate, ethylene carbonate, propylene carbonate, butylene carbonate, gamma-butyrolactone, ethylene glycol sulfite, 1,2-dimethoxyethane, 1,3 dioxolan, tetrahydrofuran, 2-methyl-tetrahydrofuran, and diethyl ether, for example. The concentration of the lithium salt in the nonaqueous electrolytic solution is preferably 0.5 to 1.5 mold, especially 0.9 to 1.25 mold. In order to improve the properties such as the safety, the charge/discharge cycle characteristics, and the high-temperature storage behavior, an additive such as vinylene carbonates, 1,3-propane sultone, diphenyl disulfide, cyclohexylbenzene, biphenyl, fluorobenzene, and t-butylbenzene can be added to the electrolytic solution as appropriate.

The nonaqueous electrolytic solution described above may be used as a gel (gel electrolyte) by adding a known gelation agent such as a polymer to the solution.

The lithium ion secondary battery of the present invention can be in the shape of a cylinder (rectangular cylinder and circular cylinder) using a steel can, an aluminum can, etc. as an exterior can. Alternatively, it can be a soft packaged battery using a metallized laminate film as an exterior sheath.

### EXAMPLES

The present invention will be described in detail by way of examples. It should be noted that the following examples are not intended to limit the invention.

### Example 1

### Preparation of Negative Electrode

Bundles of carbon nanotubes (average length of carbon nanotubes: 970 nm), 0.4 g, were added to a solution prepared by dissolving 0.4 g of DNA in 40 ml of water and mixed for five hours, to prepare a carbon nanotube dispersion.

Fifteen grams of the carbon nanotube dispersion and 35 g of a CMC aqueous solution (concentration: 1.5 mass %) were mixed, and 48 g of scaly graphite (produced by Hitachi Chemical Co., Ltd.; average particle size of primary particles: about 450 μm) and 0.5 g of SBR as a viscosity adjuster were added to the mixed solution and mixed, to obtain a negative-electrode mixture-containing composition containing 4 parts by mass of carbon nanotubes with respect to 100 parts by mass of active material particles (scaly graphite).

<Preparation of Lithium Ion Secondary Battery (Test Cell)>

The above negative-electrode mixture-containing composition was applied to one surface of an 8-μm-thick copper foil sheet that was to be the current collector using an applicator, then dried, and pressed. The resultant body was cut into 35×35 mm pieces, to prepare the negative electrode. In the resultant negative electrode, the amount of negative-electrode active material particles per unit area in the negative-electrode mixture layer was 13 mg/cm², the thickness of the negative-electrode mixture layer was 98 μm, and the density of the negative-electrode mixture layer was 1.4 g/cm³. Also, in the negative-electrode mixture layer of the negative electrode, the content of the carbon nanotubes was 4 parts by mass with respect to 100 parts by mass of the active material particles, and the content of the DNA was 100 parts by mass with respect to 100 parts by mass of the carbon nanotubes.

Similarly, 94 parts by mass of Li_{1.02}Ni_{0.5}Mn_{0.2}Co_{0.3}O₂ (average particle size of primary particles: 15 μm) as the positive-electrode active material, 4 parts by mass of acetylene black, and 2 parts by mass of PVDF were dispersed in NMP, to prepare a positive-electrode mixture-containing composition. This composition was applied to one surface of a 15-μm-thick aluminum foil sheet that was to be the current collector using an applicator so that the amount of the active material should be 20 mg/cm², then dried, and pressed. The resultant body was cut into 30×30 mm pieces, to prepare the positive electrode. The thickness of the positive-electrode mixture layer of the resultant positive electrode was 75 μm.

The positive electrode and the negative electrode described above were placed one upon the other with a separator (16-μm-thick PE microporous membrane) therebetween, and inserted into a laminate film exterior sheath. A nonaqueous electrolyte solution (solution of LiPF₆ dissolved in a concentration of 1.2 M in a mixed solvent of ethylene carbonate and diethyl carbonate at a volume ratio of 3:7) was poured into the laminate film exterior sheath, which was then sealed, to prepare a test cell.

### Example 2

A carbon nanotube dispersion was prepared in the same manner as in Example 1 except that 0.1 g of bundles of carbon nanotubes (average length of carbon nanotubes: 970 nm) were added to a solution prepared by dissolving 0.1 g of DNA in 400 ml of water, and a negative-electrode mixture-containing composition was prepared in the same manner as in Example 1 except for using this carbon nanotube dispersion. A negative electrode was then prepared in the same manner as in Example 1 except for using this negative-electrode mixture-containing composition.

The resultant negative electrode was the same as the negative electrode prepared in Example 1 in all of the amounts of negative-electrode active material particles per unit area in the negative-electrode mixture layer, the thickness of the negative-electrode mixture layer, and the density of the negative-electrode mixture layer. Also, in the negative-electrode mixture layer of the negative electrode, the content of the carbon nanotubes was 0.1 parts by mass with respect to 100 parts by mass of the active material particles, and the content of the DNA was 100 parts by mass with respect to 100 parts by mass of the carbon nanotubes.

Moreover, a lithium ion secondary battery (test cell) was prepared in the same manner as in Example 1 except for using the above electrode.

### Example 3

A carbon nanotube dispersion was prepared in the same manner as in Example 1 except that 0.5 g of bundles of carbon nanotubes (average length of carbon nanotubes: 970 nm) were added to a solution prepared by dissolving 0.5 g of DNA in 400 ml of water, and a negative-electrode mixture-containing composition was prepared in the same manner as in Example 1 except for using this carbon nanotube dispersion. A negative electrode was then prepared in the same manner as in Example 1 except for using this negative-electrode mixture-containing composition.

The resultant negative electrode was the same as the negative electrode prepared in Example 1 in all of the amounts of negative-electrode active material particles per unit area in the negative-electrode mixture layer, the thickness of the negative-electrode mixture layer, and the density of the negative-electrode mixture layer. Also, in the negative-electrode mixture layer of the negative electrode, the content of the carbon nanotubes was 0.5 parts by mass with respect to 100 parts by mass of the active material particles, and the content of the DNA was 100 parts by mass with respect to 100 parts by mass of the carbon nanotubes.

Moreover, a lithium ion secondary battery (test cell) was prepared in the same manner as in Example 1 except for using the above electrode.

### Example 4

A carbon nanotube dispersion was prepared in the same manner as in Example 1 except that 0.5 g of bundles of carbon nanotubes (average length of carbon nanotubes: 970 nm) were added to a solution prepared by dissolving 0.25 g of DNA in 400 ml of water, and a negative-electrode mixture-containing composition was prepared in the same manner as in Example 1 except for using this carbon nanotube dispersion. A negative electrode was then prepared in the same manner as in Example 1 except for using this negative-electrode mixture-containing composition.

The resultant negative electrode was the same as the negative electrode prepared in Example 1 in all of the amounts of negative-electrode active material particles per unit area in the negative-electrode mixture layer, the thickness of the negative-electrode mixture layer, and the density of the negative-electrode mixture layer. Also, in the negative-electrode mixture layer of the negative electrode, the content of the carbon nanotubes was 0.5 parts by mass with respect to 100 parts by mass of the active material particles, and the content of the DNA was 50 parts by mass with respect to 100 parts by mass of the carbon nanotubes.

Moreover, a lithium ion secondary battery (test cell) was prepared in the same manner as in Example 1 except for using the above electrode.

### Example 5

A carbon nanotube dispersion was prepared in the same manner as in Example 1 except that 0.5 g of bundles of carbon nanotubes (average length of carbon nanotubes: 970 nm) were added to a solution prepared by dissolving 0.5 g of DNA in 400 ml of water. Fifteen grams of this carbon nanotube dispersion and 35 g of a CIVIC aqueous solution (concentration: 1.5 mass %) were mixed, and 48 g of scaly graphite (produced by Hitachi Chemical Co., Ltd.; average particle size of primary particles: about 450 μm), 0.48 g of acetylene black as a particulate conductive auxiliary agent, and 0.5 g of SBR as a viscosity adjuster were added to the mixed solution and mixed, to obtain a negative-electrode mixture-containing composition containing 0.5 parts by mass of carbon nanotubes and 1.0 part by mass of acetylene black with respect to 100 parts by mass of active material particles (scaly graphite). A negative electrode was then prepared in the same manner as in Example 1 except for using this negative-electrode mixture-containing composition.

The resultant negative electrode was the same as the negative electrode prepared in Example 1 in all of the amounts of negative-electrode active material particles per unit area in the negative-electrode mixture layer, the thickness of the negative-electrode mixture layer, and the density of the negative-electrode mixture layer. Also, the content of the DNA was 100 parts by mass with respect to 100 parts by mass of the carbon nanotubes.

Moreover, a lithium ion secondary battery (test cell) was prepared in the same manner as in Example 1 except for using the above electrode.

### Comparative Example 1

Forty-eight grams of scaly graphite (produced by Hitachi Chemical Co., Ltd.; average particle size of primary particles: about 450 μm) and 0.5 g of SBR as a viscosity adjuster were added to and mixed with 35 g of a CIVIC aqueous solution (concentration: 1.5 mass %) without use of a carbon nanotube dispersion, to prepare a negative-electrode mixture-containing composition, and a negative electrode was prepared in the same manner as in Example 1 except for using this negative-electrode mixture-containing composition. The resultant negative electrode was the same as the negative electrode prepared in Example 1 in all of the amount of negative-electrode active material particles per unit area in the negative-electrode mixture layer, the thickness of the negative-electrode mixture layer, and the density of the negative-electrode mixture layer.

Moreover, a lithium ion secondary battery (test cell) was prepared in the same manner as in Example 1 except for using the above electrode.

### Comparative Example 2

A carbon nanotube dispersion was prepared in the same manner as in Example 1 except that 0.6 g of bundles of carbon nanotubes (average length of carbon nanotubes: 970 nm) were added to a solution prepared by dissolving 0.6 g of DNA in 40 ml of water, and a negative-electrode mixture-containing composition was prepared in the same manner as in Example 1 except for using this carbon nanotube dispersion. A negative electrode was then prepared in the same manner as in Example 1 except for using this negative-electrode mixture-containing composition.

The resultant negative electrode was the same as the negative electrode prepared in Example 1 in all of the amounts of negative-electrode active material particles per unit area in the negative-electrode mixture layer, the thickness of the negative-electrode mixture layer, and the density of the negative-electrode mixture layer. Also, in the negative-electrode mixture layer of the negative electrode, the content of the carbon nanotubes was 6.0 parts by mass with respect to 100 parts by mass of the active material particles, and the content of the DNA was 100 parts by mass with respect to 100 parts by mass of the carbon nanotubes.

Moreover, a lithium ion secondary battery (test cell) was prepared in the same manner as in Example 1 except for using the above electrode.

### <Load Characteristics>

The test cells of Examples 1-5 and Comparative Examples 1 and 2 were subjected to constant current charge at a current value of 1 C until the voltage became 4.2 V, and subsequently subjected to constant voltage charge at 4.2 V. The total charge time of the constant current charge and the constant voltage charge was two hours. Thereafter, the test cells were discharged until the voltage became 2.5 V at a current value of 0.2 C, to determine 0.2 C discharged capacities.

Also, after having been charged under the same conditions as those described above, the test cells were discharged until the voltage became 2.5 V at a current value of 2 C, to determine 2 C discharged capacities. Then, for each of the test cells, the 2 C discharged capacity was divided by the 0.2 C discharged capacity, to obtain a capacity retention rate expressed as a percentage. It can be said that the larger the capacity retention rate, the better the load characteristics of the test cell are. The improvement rate X of the capacity retention rate A of each test cell relative to the capacity retention rate B of the test cell of Comparative Example 1 was calculated according to the following expression.

X(%)=100×(A−B)/B

The details of the negative-electrode mixture layers of the negative electrodes used for the test cells of Examples 1-5 and Comparative Examples 1 and 2, as well as the results of the calculation described above, are shown in Table 1.

TABLE 1

| | Negative-electrode mixture layer | | | | | | |
|---|---|---|---|---|---|---|---|
| | Content of | Average | | | | Load characteristics | |
| | carbon | number of | Content | | | Capacity | |
| | nanotubes | carbon | of DNA | | | retention | Improvement |
| | (parts by | nanotubes | (parts by | Thickness | Density | rate | rate |
| | mass) | (pcs.) | mass) | (μm) | (g/cm³) | (%) | (%) |
| Example 1 | 4.0 | 1.7 | 100 | 98 | 1.4 | 78 | 2.6 |
| Example 2 | 0.1 | 1.1 | 100 | 98 | 1.4 | 80 | 5.3 |
| Example 3 | 0.5 | 1.2 | 100 | 98 | 1.4 | 85 | 11.8 |
| Example 4 | 0.5 | 1.2 | 50 | 98 | 1.4 | 81 | 6.6 |
| Example 5 | 0.5 | 1.2 | 100 | 98 | 1.4 | 87 | 14.5 |
| Comp. Ex. 1 | 0 | — | 0 | 98 | 1.4 | 76 | — |
| Comp. Ex. 2 | 6.0 | 1.9 | 100 | 98 | 1.4 | 73 | −3.9 |

The “content of carbon nanotubes” in Table 1 refers to the content (parts by mass) of carbon nanotubes with respect to 100 parts by mass of active material particles, and the “content of DNA” refers to the content (parts by mass) of DNA with respect to 100 parts by mass of carbon nanotubes (this also applies to Tables 2-5 to follow). The “average number of carbon nanotubes” in Table 1 refers to the average value of the numbers of carbon nanotubes included in the nanotube-present regions of the negative electrode mixture layer where carbon nanotubes dispersed in the negative electrode mixture layer are present, as measured by the method described above (this also applies to Tables 2-5 to follow).

As shown in Table 1, the test cells of Examples 1-5 each of which includes the negative electrode having the negative-electrode mixture layer containing carbon nanotubes and DNA exhibit excellent load characteristics, compared with the test cell of Comparative Example 1 of which the negative electrode contains no carbon nanotubes, although the content of the carbon nanotubes in the negative-electrode mixture layer is very small. In addition, especially excellent improvement in load characteristics is recognized in the test cell of Example 5 where the particulate conductive auxiliary agent was used together with the carbon nanotubes as the conductive auxiliary agent of the negative-electrode mixture layer.

In contrast to the above, the test cell of Comparative Example 2 of which the negative electrode contains an excessively large amount of carbon nanotubes in the negative-electrode mixture layer deteriorates in its load characteristics.

### Example 6

A negative electrode was prepared in the same manner as in Example 3 except that the pressing conditions after the formation of the negative-electrode mixture layer were changed to have a thickness of the negative-electrode mixture layer of 92 μm and a density of the negative-electrode mixture layer of 1.5 g/cm³.

Moreover, a lithium ion secondary battery (test cell) was prepared in the same manner as in Example 1 except for using the above electrode.

### Example 7

A negative electrode was prepared in the same manner as in Example 3 except that the pressing conditions after the formation of the negative-electrode mixture layer were changed to have a thickness of the negative-electrode mixture layer of 86 μm and a density of the negative-electrode mixture layer of 1.6 g/cm³.

Moreover, a lithium ion secondary battery (test cell) was prepared in the same manner as in Example 1 except for using the above electrode.

The load characteristics of the test cells of Examples 6 and 7 were calculated in a manner similar to that for the test cells of Example 1, etc. The details of the negative-electrode mixture layers of the negative electrodes used for the test cells of Examples 6 and 7, as well as the results of the above calculation, are shown in Table 2. Note that Table 2 also shows the details of the negative electrode used for the test cell of Example 3 and the calculation results of this test cell.

TABLE 2

| | Negative-electrode mixture layer | | | | | |
|---|---|---|---|---|---|---|
| | | Average | | | | Load |
| | | number | | | | charac- |
| | Content of | of | Content | | | teristics |
| | carbon | carbon | of DNA | | | Capacity |
| | nanotubes | nano- | (parts | Thick- | | retention |
| | (parts by | tubes | by | ness | Density | rate |
| | mass) | (pcs.) | mass) | (μm) | (g/cm³) | (%) |
| Example 3 | 0.5 | 1.2 | 100 | 98 | 1.4 | 85 |
| Example 6 | 0.5 | 1.2 | 100 | 92 | 1.5 | 74 |
| Example 7 | 0.5 | 1.2 | 100 | 86 | 1.6 | 67 |

As shown in Table 2, the lower the density of the negative-electrode mixture layer, the better the load characteristics are, and the more significant the effect of the present invention is where carbon nanotubes and DNA are used and the content of the carbon nanotubes is adjusted to an appropriate amount. It is presumed that, when the density of the negative-electrode mixture layer is high, the electron conductivity between active material particles is easily secured, and this may reduce the effect of using carbon nanotubes together with DNA.

### Comparative Example 3

A negative electrode was prepared in the same manner as in Comparative Example 1 except that the pressing conditions after the formation of the negative-electrode mixture layer were changed to have a thickness of the negative-electrode mixture layer of 86 μm and a density of the negative-electrode mixture layer of 1.6 g/cm³.

Moreover, a lithium ion secondary battery (test cell) was prepared in the same manner as in Example 1 except for using the above electrode.

The load characteristics of the test cell of Comparative Example 3 were calculated in a manner similar to that for the test cells of Example 1, etc. The details of the negative electrode used for the test cell of Comparative Example 3, as well as the results of the above calculation, are shown in Table 3. Table 3 also shows the details of the negative-electrode mixture layer of the negative electrode used for the test cell of Example 7 and the calculation results of this test cell, as well as the improvement rate of the test cell of Example 7 relative to the capacity retention rate of the test cell of Comparative Example 3 obtained at the calculation of its load characteristics.

TABLE 3

| | Negative-electrode mixture layer | | | | | | |
|---|---|---|---|---|---|---|---|
| | Content of | Average | | | | Load characteristics | |
| | carbon | number of | Content | | | Capacity | |
| | nanotubes | carbon | of DNA | | | retention | Improvement |
| | (parts by | nanotubes | (parts by | Thickness | Density | rate | rate |
| | mass) | (pcs.) | mass) | (μm) | (g/cm³) | (%) | (%) |
| Example 7 | 0.5 | 1.2 | 100 | 86 | 1.6 | 67 | 4.7 |
| Comp. Ex. 3 | 0 | — | 0 | 86 | 1.6 | 64 | — |

As show in Table 2, the test cell of Example 7 including the negative electrode having the high-density negative-electrode mixture layer is inferior in load characteristics to the test cells of Examples 3 and 6 each including the negative electrode having the negative-electrode mixture layer lower in density than that of Example 7. However, as is apparent from Table 3, an improvement in load characteristics is recognized in the test cell of Example 7 compared with the test cell of Comparative Example 3 including the negative electrode having the negative-electrode mixture layer that has the same density and contains no carbon nanotubes.

### Example 8

A negative electrode was prepared in the same manner as in Example 3 except that the amount of application of the negative-electrode mixture-containing composition to the current collector and the pressing conditions after the formation of the negative-electrode mixture layer were changed to have an amount of negative-electrode active material particles per unit area in the negative-electrode mixture layer of 20 mg/cm², a thickness of the negative-electrode mixture layer of 137 μm, and a density of the negative-electrode mixture layer of 1.4 g/cm³.

In addition, a positive electrode was prepared in the same manner as in Example 1 except that the amount of application of the positive-electrode mixture-containing composition to the current collector and the pressing conditions after the formation of the positive-electrode mixture layer were changed to have an amount of positive-electrode active material particles per unit area in the positive-electrode mixture layer of 31 mg/cm² and a thickness of the positive-electrode mixture layer of 112 μm.

Moreover, a lithium ion secondary battery (test cell) was prepared in the same manner as in Example 1 except for using the above negative electrode and the above positive electrode.

### Comparative Example 4

A negative electrode was prepared in the same manner as in Comparative Example 1 except that the amount of application of the negative-electrode mixture-containing composition to the current collector and the pressing conditions after the formation of the negative-electrode mixture layer were changed to have an amount of negative-electrode active material particles per unit area in the negative-electrode mixture layer of 20 mg/cm², a thickness of the negative-electrode mixture layer of 137 μm, and a density of the negative-electrode mixture layer of 1.4 g/cm³.

Moreover, a lithium ion secondary battery (test cell) was prepared in the same manner as in Example 1 except for using the above negative electrode.

The load characteristics of the test cells of Example 8 and Comparative Example 4 were calculated in a manner similar to that for the test cells of Example 1, etc. Table 4 shows the details of the negative-electrode mixture layers of the negative electrodes used for the test cells of Example 8 and Comparative Example 4, the results of the above evaluation, and the improvement rate of the test cell of Example 8 relative to the capacity retention rate of the test cell of Comparative Example 4 at the calculation of its load characteristics.

TABLE 4

| | Negative-electrode mixture layer | | | | | | |
|---|---|---|---|---|---|---|---|
| | Content of | Average | | | | Load characteristics | |
| | carbon | number of | Content | | | Capacity | |
| | nanotubes | carbon | of DNA | | | retention | Improvement |
| | (parts by | nanotubes | (parts by | Thickness | Density | rate | rate |
| | mass) | (pcs.) | mass) | (μm) | (g/cm³) | (%) | (%) |
| Example 8 | 0.5 | 1.2 | 100 | 137 | 1.4 | 46 | 31.4 |
| Comp. Ex. 4 | 0 | — | 0 | 137 | 1.4 | 35 | — |

As shown in Table 4, although the content of carbon nanotubes in the negative-electrode mixture layer is very small, the test cell of Example 8 including the negative electrode having the negative-electrode mixture layer containing carbon nanotubes and DNA is superior in load characteristics to the test cell of Comparative Example 4 including the negative electrode containing no carbon nanotubes. The test cell of Example 8 represents an example where its positive-electrode mixture layer and negative-electrode mixture layer were made thicker than those of the test cells of Example 1, etc. in an attempt to further increase the capacity. It is generally known that, when the electrode mixture layer of an electrode of a lithium ion secondary battery is thickened, the use efficiency of the entire active material decreases, thereby degrading the load characteristics compared with the case of a thin electrode mixture layer, as discussed earlier. However, the effect of largely improving the load characteristics is recognized also for such a battery when compared with the battery using no carbon nanotubes.

### Example 9

A negative-electrode mixture-containing composition was prepared in the same manner as in Example 3 except that the negative-electrode active material was changed from 48 g of scaly graphite to 46 g of scaly graphite and 2 g of SiO whose surface was coated with carbon (CVD-formed carbon) (mass ratio of SiO to carbon on the surface: 85:15), and a negative electrode was prepared in the same manner as in Example 1 except for using this negative-electrode mixture-containing composition. In the resultant negative electrode, the amount of negative-electrode active material particles per unit area in the negative-electrode mixture layer was 12.5 mg/cm², the thickness of the negative-electrode mixture layer was 79 μm, and the density of the negative-electrode mixture layer was 1.6 g/cm³.

Moreover, a lithium ion secondary battery (test cell) was prepared in the same manner as in Example 1 except for using the above negative electrode and the same positive electrode as that prepared in Example 8.

### Comparative Example 5

A negative-electrode mixture-containing composition was prepared in the same manner as in Comparative Example 1 except that the negative-electrode active material was changed from 48 g of scaly graphite to 46 g of scaly graphite and 2 g of SiO whose surface was coated with carbon (CVD-formed carbon) (mass ratio of SiO to carbon on the surface: 85:15), and a negative electrode was prepared in the same manner as in Example 1 except for using this negative-electrode mixture-containing composition. In the resultant negative electrode, the amount of negative-electrode active material particles per unit area in the negative-electrode mixture layer, the thickness of the negative-electrode mixture layer, and the density of the negative-electrode mixture layer were all the same as those in the negative electrode prepared in Example 9.

Moreover, a lithium ion secondary battery (test cell) was prepared in the same manner as in Example 8 except for using the above electrode.

The load characteristics of the test cells of Example 9 and Comparative Example 5 were calculated in a manner similar to that for the test cells of Example 1, etc. Table 5 shows the details of the negative-electrode mixture layers of the negative electrodes used for the test cells of Example 9 and Comparative Example 5, the results of the above evaluation, and the improvement rate of the test cell of Example 9 relative to the capacity retention rate of the test cell of Comparative Example 5 obtained at the calculation of its load characteristics.

TABLE 5

| | Negative-electrode mixture layer | | | | | | |
|---|---|---|---|---|---|---|---|
| | Content of | Average | | | | Load characteristics | |
| | carbon | number of | Content | | | Capacity | |
| | nanotubes | carbon | of DNA | | | retention | Improvement |
| | (parts by | nanotubes | (parts by | Thickness | Density | rate | rate |
| | mass) | (pcs.) | mass) | (μm) | (g/cm³) | (%) | (%) |
| Example 9 | 0.5 | 1.2 | 100 | 79 | 1.6 | 58 | 34.9 |
| Comp. Ex. 5 | 0 | — | 0 | 79 | 1.6 | 43 | — |

As shown in Table 5, although the content of carbon nanotubes in the negative-electrode mixture layer is very small, the test cell of Example 9 including the negative electrode having the negative-electrode mixture layer containing carbon nanotubes and DNA is superior in load characteristics to the test cell of Comparative Example 5 including the negative electrode containing no carbon nanotubes. The test cell of Example 9 represents an example where its positive-electrode mixture layer is made thicker than those of the test cells of Example 1, etc. and SiO that is higher in capacity than scaly graphite is used together with scaly graphite for the negative-electrode active material, in an attempt to further increase the capacity. For such a battery, also, the effect of largely improving the load characteristics is recognized when compared with the battery using no carbon nanotubes.

### INDUSTRIAL APPLICABILITY

The lithium ion secondary battery of the present invention, which can secure excellent load characteristics and charge/discharge cycle characteristics, for example, is suitably usable for uses where such characteristics are especially asked for, and, in addition, usable for the same various uses as those for which conventionally known lithium ion secondary batteries are being used.

1. An electrode for a lithium ion secondary battery, comprising an electrode mixture layer containing active material particles capable of occluding/releasing Li, a conductive auxiliary agent, and a resin binder,
wherein the electrode mixture layer contains carbon nanotubes as the conductive auxiliary agent and deoxyribonucleic acid as a dispersant for the carbon nanotubes, and
the content of the carbon nanotubes in the electrode mixture layer is 0.001 to 5 parts by mass with respect to 100 parts by mass of the active material particles.

2. The electrode for a lithium ion secondary battery of claim 1, wherein the content of the carbon nanotubes in the electrode mixture layer is 0.1 to 5 parts by mass with respect to 100 parts by mass of the active material particles

3. The electrode for a lithium ion secondary battery of claim 1, wherein the content of the deoxyribonucleic acid in the electrode mixture layer is 30 to 120 parts by mass with respect to 100 parts by mass of the carbon nanotubes.

4. The electrode for a lithium ion secondary battery of claim 1, wherein the thickness of the electrode mixture layer is 80 to 200 μm.

5. The electrode for a lithium ion secondary battery of claim 1, wherein the average length of the carbon nanotubes is 50 nm or more.

6. The electrode for a lithium ion secondary battery of claim 1, wherein the average value of the numbers of carbon nanotubes included in regions of the electrode mixture layer where carbon nanotubes dispersed in the electrode mixture layer are present is less than 2.

7. The electrode for a lithium ion secondary battery of claim 1, wherein the electrode mixture layer further contains a particulate conductive auxiliary agent.

8. The electrode for a lithium ion secondary battery of claim 7, wherein the particulate conductive auxiliary agent is acetylene black or furnace black.

9. The electrode for a lithium ion secondary battery of claim 7, wherein the content of the particulate conductive auxiliary agent in the electrode mixture layer is 0.5 to 10 parts by mass with respect to 100 parts by mass of the active material particles.

10. A method for producing an electrode for a lithium ion secondary battery, comprising the steps of:
preparing a carbon nanotube dispersion containing deoxyribonucleic acid, carbon nanotubes, and a solvent;
preparing an electrode mixture-containing composition by mixing active material particles and a resin binder in the carbon nanotube dispersion; and
forming an electrode mixture layer by applying the electrode mixture-containing composition to a current collector and drying the composition.

11. A lithium ion secondary battery comprising a positive electrode, a negative electrode, a nonaqueous electrolytic solution, and a separator,
wherein the positive electrode and/or the negative electrode is the electrode for a lithium ion secondary battery of claim 1.
